(19) United States
(12) Patent Application Publication
(10) Pub. No.: US 2009/0185507 A1
(43) Pub. Date: Jul. 23, 2009

(54) METHOD AND SYSTEM FOR DETERMINING TOPOLOGY OF A DYNAMIC NETWORK

(75) Inventor: Ofir Arkin, Carmiel (IL)

Correspondence Address: OLIFF & BERRIDGE, PLC, P.O. BOX 320850, ALEXANDRIA, VA, 22320-4850, US

(73) Assignee: INSIGHTIX LTD., Ra'anana (IL)

(21) Appl. No.: 12/303,003

(22) PCT Filed: May 30, 2007
(86) PCT No.: PCT/IL07/00654

§ 371 Date: Dec. 1, 2008

Related U.S. Application Data
(60) Provisional application No. 60/808,984, filed on May 30, 2006.

(51) Int. Cl. H04L 12/28

(52) U.S. Cl. 370/254

(57) ABSTRACT

The present invention provides a method and an apparatus for determining topology of a dynamic network in respect of which there is maintained network data containing (a) node data representing a set of nodes, (b) address data representing a respective MAC (Media Access Control) address of each node, and (c) connectivity data representing a respective connectivity of each node. The dynamic network is cyclically monitored so as to determine during each cycle new nodes that have been connected to the dynamic network since a previous cycle and vanished nodes that have been disconnected from the dynamic network since the previous cycle. The respective connectivity of each new node is determined by identifying a port in a switch to which the respective new node is connected. The network data is augmented so as to include node data representative of the new nodes, and the respective address data and connectivity data of each new node, while node data representative of each vanished node is removed from the network data, as well the respective address data and connectivity data thereof. At the end of each cycle the respective connectivity data of all nodes in the set are indicative of the respective network topology.

### FIELD OF THE INVENTION

This invention relates to the field of communication network topology. More specifically, this invention relates to determining topology of a dynamic network.

### BACKGROUND OF THE INVENTION

WO 2005/053230 provides a method and a system for collecting information relating to a communication network. Data conveyed by nodes operating in the communication network is detected in a manner that is transparent to the nodes. The detected data is analyzed for identifying information relating to the communication network and for identifying missing information. In order to complete the missing information, one or more of the nodes are queried.

Collecting information relating to a communication network is dealt with not only in patent publications. To this end, see, for example, the article “The Present and Future of Xprobe2, The Next Generation of Active Operating System Fingerprinting” (Ofir Arkin et al., published on the Internet in July 2003, see http://www.sys-security.com/archive/papers/Present and Future Xprobe2-v1.0.pdf) describing a system performing active operating system fingerprinting. According to The Present and Future of Xprobe2, active operating system fingerprinting is the process of actively determining a targeted network node's underlying operating system by probing the targeted system with several packets and examining the response(s) received.

“Topology discovery for Large Ethernet Networks” (Bruce Lowekamp et al., SIGCOMM '01, Aug. 27-31, 2001, San Diego, Calif., USA) teaches how to determine the connection between a pair of bridges that share forwarding entries for only three hosts, requiring access to only one endpoint to perform the queries needed for topology discovery.

“Topology discovery in heterogeneous IP networks” (Y. Breitbart et al., in proceedings of INFOCOM 2000, March 2000) describes discovering physical topology in heterogeneous (i.e., multi-vendor) IP networks, relying on standard SNMP MIB information. The method of Breitbard et al. can discover the physical network topology in time that is roughly quadratic in the number of network elements.

“Physical Topology Discovery for Large Multi-Subnet Networks” (Y. Bejerano et al., in proceedings of INFOCOM 2003) describes an algorithmic solution for discovering the physical topology of a large, heterogeneous Ethernet network comprising multiple subnets as well as dumb or uncooperative network elements. The algorithm relies on standard SNMP MIB information.

### SUMMARY OF THE INVENTION

The invention provides a method for determining topology of a dynamic network in respect of which there is maintained network data containing (a) node data representing a set of nodes, (b) address data representing a respective MAC (Media Access Control) address of each node and (c) connectivity data representing a respective connectivity of each node, the method comprising:

cyclically monitoring the dynamic network so as to determine during each cycle new nodes that have been connected to the dynamic network since a previous cycle and vanished nodes that have been disconnected from the dynamic network since the previous cycle;

determining the respective connectivity of each new node by identifying a port in a switch to which the respective new node is connected;

augmenting said network data so as to include node data representative of the new nodes, and the respective address data and connectivity data of each new node; and

removing node data representative of each vanished node as well its respective address data and connectivity data from said network data;

whereby at the end of each cycle the respective connectivity data of all nodes in said set are indicative of the respective network topology.

The invention further provides an apparatus for determining topology of a dynamic network, the apparatus comprising:

a memory device for maintaining network data containing (a) node data representing a set of nodes, (b) address data representing a respective MAC (Media Access Control) address of each node and (c) connectivity data representing a respective connectivity of each node,

a monitoring module for cyclically monitoring the dynamic network so as to determine during each cycle new nodes that have been connected to the dynamic network since a previous cycle and vanished nodes that have been disconnected from the dynamic network since the previous cycle;

a connectivity determining module for determining the respective connectivity of each new node by identifying a port in a switch to which the respective new node is connected;

a network data augmenting module for augmenting said network data so as to include node data representative of the new nodes, and the respective address data and connectivity data of each new node; and

a network data removing module for removing node data representative of each vanished node as well its respective address data and connectivity data from said network data.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic illustration of a network including a topology detector, according to one embodiment of the invention;

FIG. 2 is a flowchart illustrating the main procedures taken while determining topology of a dynamic network, according to one embodiment of the invention;

FIG. 3 is a flowchart illustrating determining network connectivity, according to one embodiment of the invention;

FIG. 4 is a flowchart illustrating determining the respective connectivity of a new node, according to one embodiment of the invention;

FIG. 5 is a flowchart illustrating removing node data, address data and connectivity data respective to a vanished node from the network data, according to one embodiment of the invention; and

FIG. 6 is a block diagram illustrating a topology detector, according to one embodiment of the invention.

### DETAILED DESCRIPTION OF EMBODIMENTS

In the following description components that are common to more than one figure will be referenced by the same reference numerals,

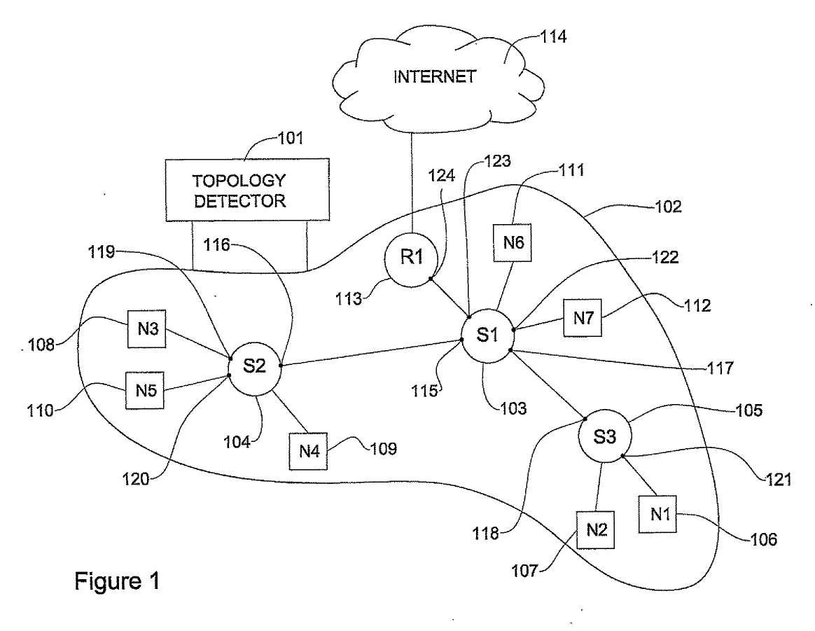

FIG. 1 is a schematic illustration of a system named a topology detector 101 coupled to a network 102, according to one embodiment of the invention. The network constitutes a “monitored communication network”. According to the example, there are three switches, 103, 104 and 105, included in the network 102, Each switch (103, 104 and 105) is coupled to “elements”, or “nodes” in the network. Specifically, in the figure these are nodes 106 and 107 that are coupled to the network 102 via switch 105, nodes 108, 109 and 110, which are coupled via switch 104, and nodes 111 and 112 that are coupled to the network 102 via switch 103. The switch 103 is coupled also to a router 113 connecting the network 102 and the nodes being part thereof to the Internet 114.

Hereinafter, every element coupled to a network will be considered as a node, including switches and routers. According to the invention, each node is characterized, amongst other things, by a classification indicative of the type of the node, wherein a node can be classified, e.g., as a switch, a router, a host, a printer, a terminal, etc. In addition, switches and routers are joined under a single super-classification constituting “connecting nodes”. All other nodes constitute together “end nodes”.

The term “connectivity data” is used for describing a first node and a second node coupled thereto. If the first node is a connecting node, “connectivity data” refers to a port in the connecting node and the node coupled thereto. Even further, “connectivity data of a node” refers to the node and another node (or port) coupled thereto. The respective connectivity data of all the nodes being part of a network are indicative of the respective network topology.

It is noted that FIG. 1 presents a non-limiting example while the nodes being part of the network 102 and the network's respective topology can be different than what is illustrated in the figure. For example, there can be any applicable number of switches and any switch be coupled to any number of nodes, including more than one router, etc.

According to the embodiment, the topology detector 101 maintains node data representing a set of nodes being part of a network. In the example of FIG. 1, the node data represents a set including nodes {103, 104, 105, 106, 107, 108, 109, 110, 111, 112}. It is appreciated that in order to determine which nodes are represented in the node data, prima facie those versed in the art may apply, e.g., the method taught by WO 2005/053230.

In addition, the topology detector 101 maintains address data representing a respective MAC (Media Access Control) address of each node and connectivity data representing a respective connectivity of each node. The node data, address data and connectivity data constitute together “network data”. While it appears as if the MAC address of each node can be determined, e.g., in accordance with WO 2005/053230, it can be mistakenly considered that connectivity data of all the nodes in a network can be determined, e.g., in accordance with the articles “Topology discovery for Large Ethernet Networks” or in accordance with “Topology discovery in heterogeneous IP networks”.

It should be appreciated that a topology detector 101 operating in accordance with WO 2005/053230, applies passive and active methods for collecting information. Therefore the topology detector 101 has two connections coupling it to the network 102.

However, it should be appreciated that a network (such as network 102) can be a “dynamic network” wherein “new nodes” can connect thereto from time to time, while “vanished nodes” can disconnect therefrom. The embodiment illustrated hereinafter provides a method for determining topology of a dynamic network.

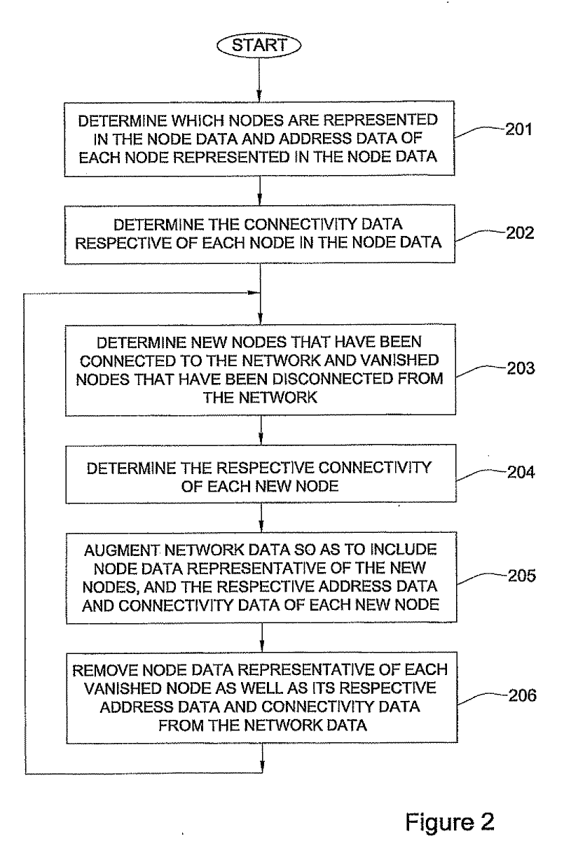

FIG. 2 is a flowchart illustrating the main procedures taken while determining topology of a dynamic network, according to one embodiment of the invention. Upon startup, on 201 the topology detector 101 determines which nodes are represented in the node data, e.g., by applying the passive and/or active methods of WO 2005/053230. The node data generated by 201 constitutes a “baseline”. It should be appreciated that the node data is stored in a memory device accessible to the topology detector 101, while the memory device can be a short term memory device (such as Random Access Memory, RAM) or a long term memory device (such as a disk, flash memory etc.). The methods of WO 2005/053230 can reveal also the MAC address of each node, hence 201 includes also determining address data representing a respective MAC address of each node. Like the node data, address data is also stored in a short or long term memory device accessible to the topology detector.

Then, on 202, the topology detector 101 determines the connectivity data respective of each node in the node data, e.g., in accordance with “Topology discovery for Large Ethernet Networks” or “Topology discovery in heterogeneous IP networks”. Similarly to the node data and to the address data, the topology detector stores the connectivity data in a memory device accessible thereto. Like the previously mentioned memory devices, the present memory device can also be a short term memory device or a long term memory device.

Because the network is a dynamic network, it has to be cyclically monitored, thus determining on 203 during each cycle new nodes that have been connected to the network since a previous cycle and vanished nodes that have been disconnected from the dynamic network since the previous cycle. On 204 the topography detector 101 determines the respective connectivity of each new node determined on 203, and on 205 it augments the network data so as to include node data representative of the new nodes, and the respective address data and connectivity data of each new node. On 206 node data representative of each vanished node as well its respective address data and connectivity data is removed from the network data.

It should be appreciated that the flowchart of FIG. 2 is non-limiting and other alternatives may exist. For example, it was previously explained that each of the node data, the address data and the connectivity data are stored in a short or long term memory device. Therefore, those versed in the art would appreciate that instead of determining the node data, and/or the address data and/or the connectivity data it is possible to obtain any one of them, e.g., by reading them from disk, obtaining them from the communication network etc. Generally, therefore, the network data is considered to be maintained, wherein maintaining includes determining and/or obtaining.

It should also be appreciated that the topology detector can cyclically monitory the dynamic network in near real time mode. In this case, the operating system can provide the cyclicality, e.g., by polling a file descriptor.

Turning now to determining connectivity data on 202, for each connecting device the connectivity of each port is classified, wherein possible port classifications are “inter-switch connecting port”, “switch-router connecting port” and “end-node port”. An inter-switch connecting port is a port on a switch, in use for connecting to another switch. In the example FIG. 1 four inter-switch connecting ports are illustrated. Specifically, they are referenced by reference numerals 115, 116, 117 and 118. A switch-router connecting port is a port on a switch in use for connecting to a router. A port on a router in use for connecting to a switch is also classified as a switch-router connecting port. Hence, in the example of FIG. 1, wherein only one router is depicted (113), there are two switch-router connecting ports, marked by the reference numerals 123 and 124. A port on a switch or on a router, in use for connecting to an end-node, constitutes an end-node port. End-node ports in the example of FIG. 1 are 119, 120, 121, 122 and others.

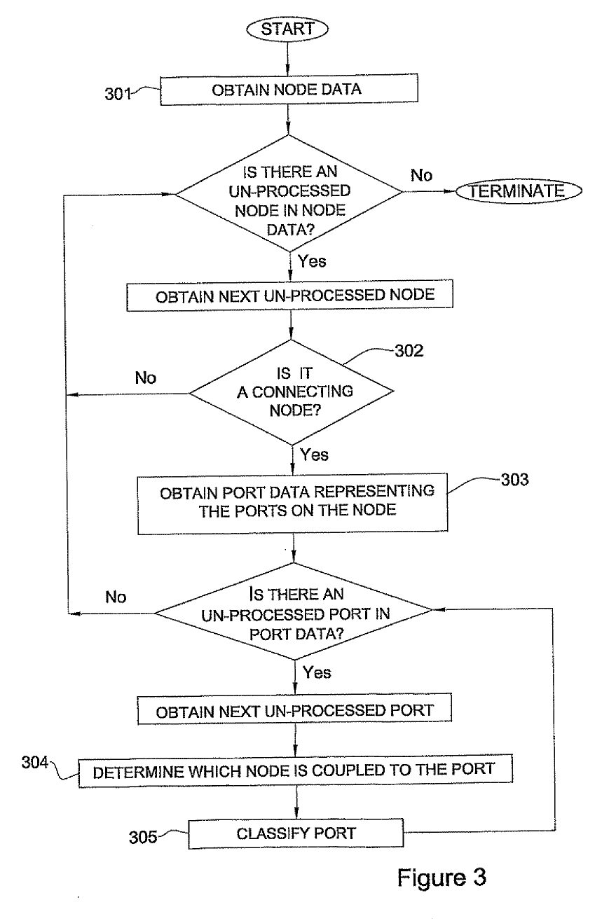

FIG. 3 is a flowchart illustrating determining network connectivity 202, according to one embodiment of the invention. Further to obtaining node data on 301, each node in the set of nodes represented by the node data is processed as follows: On 302 the classification of each un-processed node is checked, in order to determine whether this is a connecting node or an end node. If the node is an end-node, the next un-processed node is obtained from the node data. Alternatively, upon determining that the un-processed node is a connecting node, on 303 the ‘port data’ of the node is obtained wherein the port data represents a set of ports on the connecting node. For each port in the port data, determine (on 304) the node coupled to the port, and on 305 the port is classified in accordance with the classification of the coupled node. It should be appreciated by those versed in the art that according to one embodiment obtaining port data (303) and determining which port is coupled to the port (on 304) are performed using SNMP MIB information.

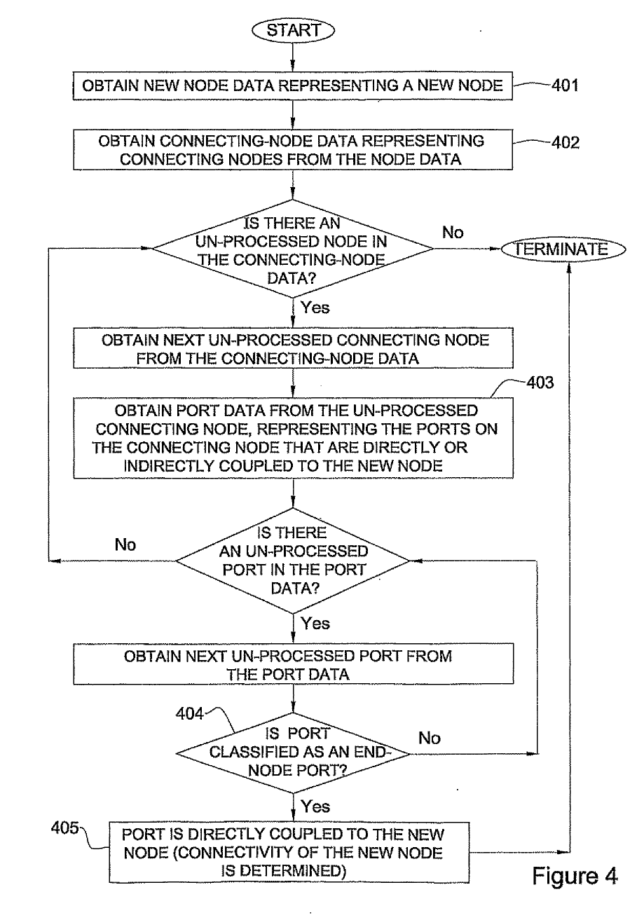

FIG. 4 is a flowchart illustrating determining the respective connectivity of a new node, according to one embodiment of the invention. Further to 401, wherein “new-node data” is obtained, representative of the new node whose respective connectivity should be determined, and further to 402, wherein “connecting-node data” representing connecting nodes in the node data is obtained, every connecting node represented in the connecting-node data is processed in order to determine whether the new node is directly coupled to a port thereof. In order to do so, on 403, port data is obtained from every connecting node represented in the connecting-node data. The port data represents those ports on the connecting node that are directly or indirectly coupled to the new node. Direct coupling means that the new node is an end node directly coupled to a port on the present connecting node. Indirect coupling means that the new node is directly coupled to another connecting node, yet, the present connecting node is familiar with the MAC address of the new node, i.e., the present connecting node is directly or indirectly coupled to the another connecting node, and via this another connecting mode indirect coupling to the new node is achieved.

Each port represented in the port data is processed and on 404 its respective classification is checked. If the port is an end-node port, this implies on 405 that the new node is directly coupled to this port and hence to the presently processed connecting node. On the other hand, if on 404 the port's classification is determined to be an inter-switch port or a switch-router port, this implies that the coupling is indirect and the flowchart continues processing other ports on the presently processed connecting node, or on other connecting nodes, looking for a direct coupling with the new node.

It should be appreciated that upon determining on 405 that one connecting node is directly coupled to the new node, connectivity of the new node is determined by the coupling of the new node to the port in the connecting node. Returning to 205 on FIG. 2, the new node's data, its respective address data, and the newly determined connectivity data are included in the augmented network data.

Yet, it should be appreciated that upon connecting a new connecting node to the network, at least one port of the new connecting node is directly coupled with at least one port of a connecting node being part of the network. However, since classification of the new connecting node reveals that the new node is a connecting node, those versed in the art might appreciate that the flowchart of FIG. 4 will erroneously identify the coupling therewith as indirect coupling. According to one embodiment of the invention, in order to overcome this problem, in 404, upon determining that an inter-switch port or a switch-router port is coupled to a connecting node to which no other nodes have been connected, this port will be temporarily considered as an end-node port, until one or more new nodes will connect to any one of the new connecting node's ports. Because a connecting node normally connects to a network before any other nodes connect thereto, the topography detector would determine that the coupling of the new connecting node to the connecting node being part of the network is direct coupling. Alternatively, immediately after determining that the new connecting node is directly coupled to the connecting node being part of the network, the ports classification can be altered to be inter-switch ports or switch-router ports as required.

In an alternative embodiment, upon obtaining an indication that a new connecting node has been connected to the network, the topography detector will reset the network data, thus returning to 201 in FIG. 2.

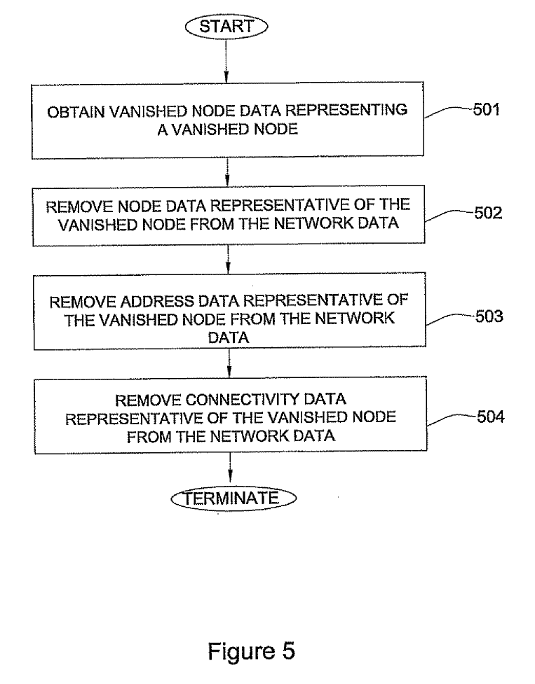

FIG. 5 is a flowchart illustrating removing node data, address data and connectivity data respective to a vanished node from the network data, according to one embodiment of the invention. According to the embodiment upon obtaining, on 501, “vanished node data”, representative of the vanished node, on 502 the topography detector removes node data representative of the vanished node from the network data, on 503 the address data representative of the vanished node is removed from the network data, and on 504 the connectivity data representative of the vanished node is removed from the network data. Hence, further to performing the operations described on 501, 502, 503 and 504 the respective connectivity data of all nodes in the network data are indicative of the respective network topology.

It can be appreciated that the flowchart of FIG. 5 is non-limiting and alternatives may exist. For example, the order of the operations performed thereby can change.

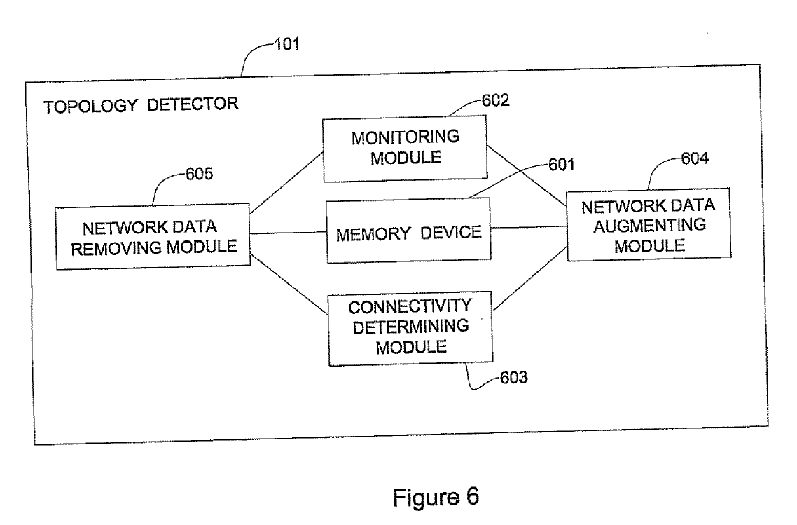

FIG. 6 is a block diagram illustrating a topology detector 101, which is an apparatus for determining topology of a dynamic network, according to one embodiment of the invention. According to the embodiment the topology detector includes a memory device 601, a monitoring module 602, a connectivity determining module 603, a network data augmenting module 604 coupled to the monitoring module 602 and to the connectivity determining module 603, and a network data removing module 605 coupled to the monitoring module 602 and to the connectivity determining module 603. Each of the monitoring module 602, the connectivity determining module 603, the network data augmenting module 604 and the network data removing module 605 is coupled to the memory device 601.

It was mentioned earlier, with reference to FIG. 2, that the memory device can be a short term memory device (such as Random Access Memory, RAM) or a long term memory device (such as a disk, flash memory etc.). In addition, it should be appreciated that although in the figure one memory device (601) is depicted, there may exist several memory devices, e.g., one for storing node data, one for storing address data and one for storing connectivity data.

According to one embodiment, the monitoring module 602 is able to perform 203 of FIG. 2. It can be appreciated therefore, that the monitoring module 602 can operate, e.g., in accordance with WO 2005/053230, in which case it can be the network information collector described therein.

Yet, according to another embodiment, the connectivity determining module 603, can operate, e.g., in accordance with the flowchart illustrated in FIG. 4. The network data augmenting module 604 can perform 205 of FIG. 2, e.g., by storing node data, address data and connectivity data in the proper memory device. Furthermore, the network data removing module 605 can operate, according to one embodiment, in accordance with the flowchart of FIG. 5.

It will also be understood that the apparatus according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1-9. (canceled)

10. A method of determining topology of a dynamic network in respect of which there is maintained network data containing (a) node data representing a set of nodes, (b) address data representing a respective MAC (Media Access Control) address of each node and (c) connectivity data representing a respective connectivity of each node, the method comprising:
cyclically monitoring the dynamic network so as to determine during each cycle new nodes that have been connected to the dynamic network since a previous cycle and vanished nodes that have been disconnected from the dynamic network since the previous cycle;
determining the respective connectivity of each new node by identifying a port in a switch to which the respective new node is connected;
augmenting said network data so as to include node data representative of the new nodes, and the respective address data and connectivity data of each new node; and
removing node data representative of each vanished node as well its respective address data and connectivity data from said network data,
whereby at the end of each cycle the respective connectivity data of all nodes in said set are indicative of the respective network topology.

11. The method according to claim 10, further comprising cyclically monitoring the dynamic network in near real-time.

12. The method according to claim 10, further comprising obtaining the maintained network data by reading the network data from a storage device, prior to cyclically monitoring the dynamic network.

13. The method according to claim 10, further comprising determining the maintained network data by analyzing the network, prior to cyclically monitoring the dynamic network.

14. The method according to claim 10, further comprising determining the respective connectivity of each new node by obtaining connecting-node data representing connecting nodes from the node data.

15. The method according to claim 14, further comprising determining the respective connectivity of each new node by obtaining port data representing ports on each connecting node, represented by the connecting-node data, said port data representing ports on each connecting node being directly or indirectly coupled to the new node.

16. An apparatus configured to determine topology of a dynamic network, the apparatus comprising:
a memory device for maintaining network data containing (a) node data representing a set of nodes, (b) address data representing a respective MAC (Media Access Control) address of each node and (c) connectivity data representing a respective connectivity of each node;
a monitoring module for cyclically monitoring the dynamic network so as to determine during each cycle new nodes that have been connected to the dynamic network since a previous cycle and vanished nodes that have been disconnected from the dynamic network since the previous cycle;
a connectivity determining module for determining the respective connectivity of each new node by identifying a port in a switch to which the respective new node is connected;
a network data augmenting module for augmenting said network data so as to include node data representative of the new nodes, and the respective address data and connectivity data of each new node; and
a network data removing module for removing node data representative of each vanished node as well its respective address data and connectivity data from said network data.

17. A computer program product, comprising a computer usable medium having a computer readable program code embodied therein, said computer readable program code adapted to be executed to implement a method of determining topology of a dynamic network in respect of which there is maintained network data containing (a) node data representing a set of nodes, (b) address data representing a respective MAC (Media Access Control) address of each node and (c) connectivity data representing a respective connectivity of each node, the method comprising:
cyclically monitoring the dynamic network so as to determine during each cycle new nodes that have been connected to the dynamic network since a previous cycle and vanished nodes that have been disconnected from the dynamic network since the previous cycle;
determining the respective connectivity of each new node by identifying a port in a switch to which the respective new node is connected;
augmenting said network data so as to include node data representative of the new nodes, and the respective address data and connectivity data of each new node; and
removing node data representative of each vanished node as well its respective address data and connectivity data from said network data,
whereby at the end of each cycle the respective connectivity data of all nodes in said set are indicative of the respective network topology.

18. The computer program product according to claim 17, wherein the method further comprises performing cyclically monitoring the dynamic network in near real-time.

19. The computer program product according to claim 17, wherein the method further comprises obtaining the maintained network data by reading the network data from a storage device, prior to cyclically monitoring the dynamic network.

20. The computer program product according to claim 17, wherein the method further comprises determining the maintained network data by analyzing the network, prior to cyclically monitoring the dynamic network.

21. The computer program product according to claim 17, wherein the method further comprises determining the respective connectivity of each new node by obtaining connecting-node data representing connecting nodes from the node data.

22. The computer program product according to claim 21, wherein the method further comprises determining the respective connectivity of each new node by obtaining port data representing ports on each connecting node represented by the connecting-node data, said port data representing ports on each connecting node being directly or indirectly coupled to the new node.

23. The method of determining topology of the dynamic network according to claim 10, substantially as described and illustrated.

24. The apparatus configured to determine topology of the dynamic network according to claim 16, substantially as described and illustrated.
